(19) United States
(12) Patent Application Publication
(10) Pub. No.: US 2013/0243030 A1
(43) Pub. Date: Sep. 19, 2013

(54) Augmentation of Fans With Synthetic Jet Ejectors

(71) Applicant: NUVENTIX, INC., Austin, TX (US)

(72) Inventors: Raghavendran Mahalingam, Austin, TX (US); Lee M. Jones, Austin, TX (US); Samuel N. Heffington, Tulsa, OK (US); Stephen P. Darbin, Austin, TX (US); Markus Schwickert, Scottsdale, AZ (US)

(73) Assignee: Nuventix, Inc., Austin, TX (US)

(21) Appl. No.: 13/846,646

(22) Filed: Mar. 18, 2013

Related U.S. Application Data
(60) Provisional application No. 61/611,863, filed on Mar. 16, 2012.

(51) Int. Cl. G06F 1/20; G01K 11/00

(52) U.S. Cl. CPC G06F 1/20; G01K 11/00
USPC 374/101; 361/679.47

(57) ABSTRACT

A computing device is provided which comprises (a) a chassis having an array of printed circuit boards (PCBs) disposed therein, wherein said chassis has a first wall with a first opening therein, and a second wall with a second opening therein, wherein each PCB is equipped with a microprocessor and a heat sink, and wherein each heat sink comprises a plurality of heat fins that define a plurality of longitudinal channels; (b) a fan which creates a fluidic flow that enters through said first opening and exits through said second opening, said fluidic flow being essentially parallel the longitudinal axes of said plurality of longitudinal channels; and (c) a synthetic jet ejector which directs at least one synthetic jet through at least one of said plurality of channels.

### CROSS-REFERENCE TO RELATED APPLICATION

This application claims the benefit of U.S. Provisional Application No. 61/611,863, filed Mar. 16, 2012, having the same title, and having the same inventors, and which is incorporated herein by reference in its entirety.

### FIELD OF THE DISCLOSURE

The present disclosure relates generally to synthetic jet ejectors, and more particularly to systems and methods for the augmentation of fan-based thermal management systems with synthetic jet ejectors.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile thermal management solution, especially in applications where thermal management is required at the local level.

Various examples of synthetic jet ejectors are known to the art. Earlier examples are described in U.S. Pat. No. 5,758,823 (Glezer et al.), entitled “Synthetic Jet Actuator and Applications Thereof”; U.S. Pat. No. 5,894,990 (Glezer et al.), entitled “Synthetic Jet Actuator and Applications Thereof”; U.S. Pat. No. 5,988,522 (Glezer et al.), entitled Synthetic Jet Actuators for Modifying the Direction of Fluid Flows”; U.S. Pat. No. 6,056,204 (Glezer et al.), entitled “Synthetic Jet Actuators for Mixing Applications”; U.S. Pat. No. 6,123,145 (Glezer et al.), entitled Synthetic Jet Actuators for Cooling Heated Bodies and Environments”; and U.S. Pat. No. 6,588,497 (Glezer et al.), entitled “System and Method for Thermal Management by Synthetic Jet Ejector Channel Cooling Techniques”.

Further advances have been made in the art of synthetic jet ejectors, both with respect to synthetic jet ejector technology in general and with respect to the applications of this technology. Some examples of these advances are described in U.S. 20100263838 (Mahalingam et al.), entitled “Synthetic Jet Ejector for Augmentation of Pumped Liquid Loop Cooling and Enhancement of Pool and Flow Boiling”; U.S. 20100039012 (Grimm), entitled “Advanced Synjet Cooler Design For LED Light Modules”; U.S. 20100033071 (Heffington et al.), entitled “Thermal management of LED Illumination Devices”; U.S. 20090141065 (Darbin et al.), entitled “Method and Apparatus for Controlling Diaphragm Displacement in Synthetic Jet Actuators”; U.S. 20090109625 (Booth et al.), entitled Light Fixture with Multiple LEDs and Synthetic Jet Thermal Management System”; U.S. 20090084866 (Grimm et al.), entitled Vibration Balanced Synthetic Jet Ejector”; U.S. 20080295997 (Heffington et al.), entitled Synthetic Jet Ejector with Viewing Window and Temporal Aliasing”; U.S. 20080219007 (Heffington et al.), entitled “Thermal Management System for LED Array”; U.S. 20080151541 (Heffington et al.), entitled “Thermal Management System for LED Array”; U.S. 20080043061 (Glezer et al.), entitled “Methods for Reducing the Non-Linear Behavior of Actuators Used for Synthetic Jets”; U.S. 20080009187 (Grimm et al.), entitled “Moldable Housing design for Synthetic Jet Ejector”; U.S. 20080006393 (Grimm), entitled Vibration Isolation System for Synthetic Jet Devices”; U.S. 20070272393 (Reichenbach), entitled “Electronics Package for Synthetic Jet Ejectors”; U.S. 20070141453 (Mahalingam et al.), entitled “Thermal Management of Batteries using Synthetic Jets”; U.S. 20070096118 (Mahalingam et al.), entitled “Synthetic Jet Cooling System for LED Module”; U.S. 20070081027 (Beltran et al.), entitled “Acoustic Resonator for Synthetic Jet Generation for Thermal Management”; U.S. 20070023169 (Mahalingam et al.), entitled “Synthetic Jet Ejector for Augmentation of Pumped Liquid Loop Cooling and Enhancement of Pool and Flow Boiling”; U.S. 20070119573 (Mahalingam et al.), entitled “Synthetic Jet Ejector for the Thermal Management of PCI Cards”; U.S. 20070119575 (Glezer et al.), entitled “Synthetic Jet Heat Pipe Thermal Management System”; U.S. 20070127210 (Mahalingam et al.), entitled “Thermal Management System for Distributed Heat Sources”; U.S. 20070141453 (Mahalingam et al.), entitled “Thermal Management of Batteries using Synthetic Jets”; U.S. Pat. No. 7,252,140 (Glezer et al.), entitled “Apparatus and Method for Enhanced Heat Transfer”; U.S. Pat. No. 7,606,029 (Mahalingam et al.), entitled “Thermal Management System for Distributed Heat Sources”; U.S. Pat. No. 7,607,470 (Glezer et al.), entitled “Synthetic Jet Heat Pipe Thermal Management System”; U.S. Pat. No. 7,760,499 (Darbin et al.), entitled “Thermal Management System for Card Cages”; U.S. Pat. No. 7,768,779 (Heffington et al.), entitled “Synthetic Jet Ejector with Viewing Window and Temporal Aliasing”; U.S. Pat. No. 7,784,972 (Heffington et al.), entitled “Thermal Management System for LED Array”; and U.S. Pat. No. 7,819,556 (Heffington et al.), entitled “Thermal Management System for LED Array”.

### BRIEF DESCRIPTION OF THE DRAWINGS

FIGS. 1A-1C are illustrations depicting the manner in which a synthetic jet actuator operates.

FIG. 2 is an illustration of a server chassis equipped with a fan-based thermal management system.

FIG. 3 is an illustration of a server chassis equipped with a fan-based thermal management system augmented by synthetic jet cooling.

FIG. 4 is an illustration of the air flow in the vicinity of a heat sink and heat source (microprocessor) construct in a fan-based thermal management system.

FIG. 5 is an illustration of the air flow in the vicinity of a heat sink and heat source (microprocessor) construct in a fan-based thermal management system which is augmented by a synthetic jet ejector.

FIG. 6 is an illustration of an experimental set-up for measuring the effect of augmenting a fan-based thermal management system with a synthetic jet ejector.

FIG. 7 is a graph of thermal resistance (in C/W) as a function of mean fan flow (measured in LFM) which illustrates the improvement in thermal resistance due to augmentation of a fan-based thermal management system with a synthetic jet ejector.

FIG. 8 is a graph of % improvement in thermal performance as a function of the ratio of jet LFM to mean LFM which illustrates the percent improvement in heat dissipation as a function of jet/fan LFM ratio for the augmentation of a fan-based thermal management system with a synthetic jet ejector.

FIG. 9 is an illustration of a particular, non-limiting embodiment of a server equipped with a fan-based thermal management system which is augmented by a synthetic jet ejector thermal management system.

FIG. 10 is a graph of % improvement in heat dissipation as a function of baseline fan LFM for both predicted and measured values, which illustrates the improvements in heat dissipation provided by synthetic jet ejectors at low mean flow rates.

FIG. 11 is a graph of thermal resistance (in C/W) as a function of baseline fan RPM for a thermal management system featuring only fan-based cooling, and a thermal management system featuring both fan-based cooling and synthetic jet ejector cooling.

FIG. 12 is a table showing the power consumption and acoustical footprint for a thermal management system featuring only fan-based cooling, and a thermal management system featuring both fan-based cooling and synthetic jet ejector cooling.

FIG. 13 is an illustration of the effect on cooling system reliability (as measured by estimated lifetimes) for thermal management systems featuring fan cooling only, fan-assisted augmentation, and synthetic jet ejector assisted augmentation.

FIG. 14 is an illustration of a first embodiment of a synthetic jet ejector equipped with pipes for remote cooling.

FIG. 15 is an illustration of a second embodiment of a synthetic jet ejector equipped with pipes for remote cooling.

### SUMMARY OF THE DISCLOSURE

In one aspect, a computing device is provided which comprises (a) a chassis having an array of printed circuit boards (PCBs) disposed therein, wherein said chassis has a first wall with a first opening therein, and a second wall with a second opening therein, wherein each PCB is equipped with a microprocessor and a heat sink, and wherein each heat sink comprises a plurality of heat fins that define a plurality of longitudinal channels; (b) a fan which creates a fluidic flow that enters through said first opening and exits through said second opening, said fluidic flow being essentially parallel the longitudinal axes of said plurality of longitudinal channels; and (c) a synthetic jet ejector which directs at least one synthetic jet through at least one of said plurality of channels.

In another aspect, a system for testing the effect of synthetic jet cooling in a thermal management system is provided. The system comprises (a) a conduit having a heat sink disposed therein which is in thermal contact with a heat source; (b) a heat source in thermal contact with said heat sink; (c) a synthetic jet ejector which directs a synthetic jet onto or across a surface of said heat sink; (d) a fan which creates an air flow through said conduit from a direction upstream from said heat sink to a direction downstream from said heat sink; and (e) a velocity probe.

### DETAILED DESCRIPTION

The systems, devices and methodologies disclosed herein utilize synthetic jet actuators or synthetic jet ejectors. Prior to describing these systems, devices and methodologies, a brief explanation of a typical synthetic jet ejector, and the manner in which it operates to create a synthetic jet, may be useful.

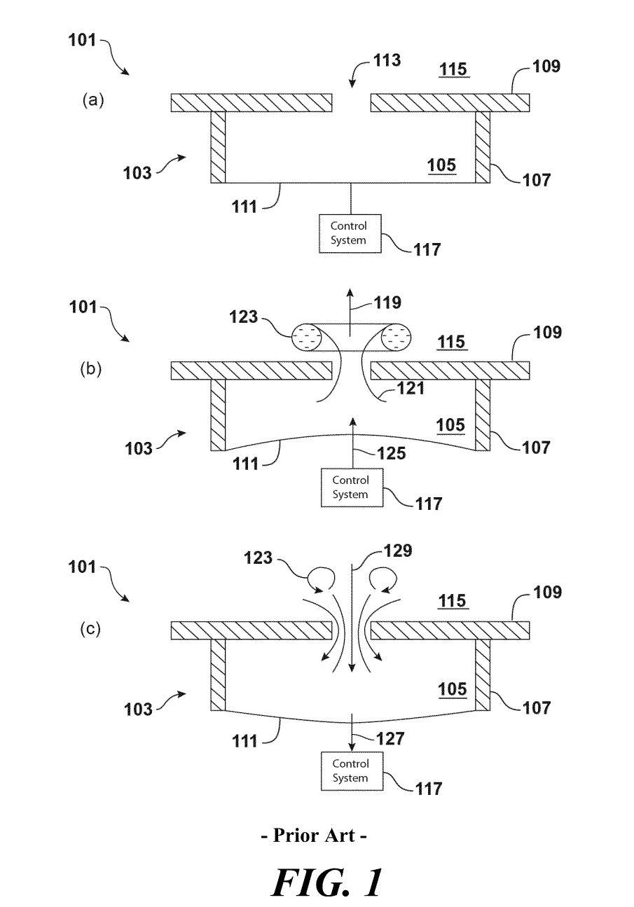

FIG. 1 illustrates the operation of a typical synthetic jet ejector in forming a synthetic jet. As seen therein, the synthetic jet ejector 101 comprises a housing 103 which defines and encloses an internal chamber 105. The housing 103 and chamber 105 may take virtually any geometric configuration, but for purposes of discussion and understanding, the housing 103 is shown in cross-section in FIG. 1 to have a rigid side wall 107, a rigid front wall 109, and a rear diaphragm 111 that is flexible to an extent to permit movement of the diaphragm 111 inwardly and outwardly relative to the chamber 105. The front wall 109 has an orifice 113 therein which may be of various geometric shapes. The orifice 113 diametrically opposes the rear diaphragm 111 and fluidically connects the internal chamber 105 to an external environment having ambient fluid 115.

The movement of the flexible diaphragm 111 may be achieved with a voice coil or other suitable actuator, and may be controlled by a suitable control system 117. The diaphragm 111 may also be equipped with a metal layer, and a metal electrode may be disposed adjacent to, but spaced apart from, the metal layer so that the diaphragm 111 can be moved via an electrical bias imposed between the electrode and the metal layer. Moreover, the generation of the electrical bias can be controlled by any suitable device including, but not limited to, a computer, logic processor, or signal generator. The control system 117 can cause the diaphragm 111 to move periodically or to modulate in time-harmonic motion, thus forcing fluid in and out of the orifice 113.

Alternatively, a piezoelectric actuator could be attached to the diaphragm 111. The control system would, in that case, cause the piezoelectric actuator to vibrate and thereby move the diaphragm 111 in time-harmonic motion. The method of causing the diaphragm 111 to modulate is not particularly limited to any particular means or structure.

The operation of the synthetic jet ejector 101 will now be described with reference to FIGS. 1b-1c. FIG. 1b depicts the synthetic jet ejector 101 as the diaphragm 111 is controlled to move inward into the chamber 105, as depicted by arrow 125. The inward motion of the diaphragm 111 reduces the volume of the chamber 105, thus causing fluid to be ejected through the orifice 113. As the fluid exits the chamber 105 through the orifice 113, the flow separates at the (preferably sharp) edges of the orifice 113 and creates vortex sheets 121. These vortex sheets 121 roll into vortices 123 and begin to move away from the edges of the orifice 109 in the direction indicated by arrow 119.

FIG. 1c depicts the synthetic jet ejector 101 as the diaphragm 111 is controlled to move outward with respect to the chamber 105, as depicted by arrow 127. The outward motion of the diaphragm 111 causes the volume of chamber 105 to increase, thus drawing ambient fluid 115 into the chamber 105 as depicted by the set of arrows 129. The diaphragm 111 is controlled by the control system 117 so that, when the diaphragm 111 moves away from the chamber 105, the vortices 123 are already removed from the edges of the orifice 113 and thus are not affected by the ambient fluid 115 being drawn into the chamber 105. Meanwhile, a jet of ambient fluid 115 is synthesized by the vortices 123, thus creating strong entrainment of ambient fluid drawn from large distances away from the orifice 109.

It has now been found that synthetic jet ejectors may be utilized advantageously in some applications to augment the fluidic flow provided by fan-based thermal management systems. This is especially so in applications involving the thermal management of computing devices, such as servers, where the turbulent, localized flow provided by synthetic jet ejectors complements the global fluidic flow provided by fans by enhancing heat transfer through boundary layer disruption along the surfaces of a heat sink.

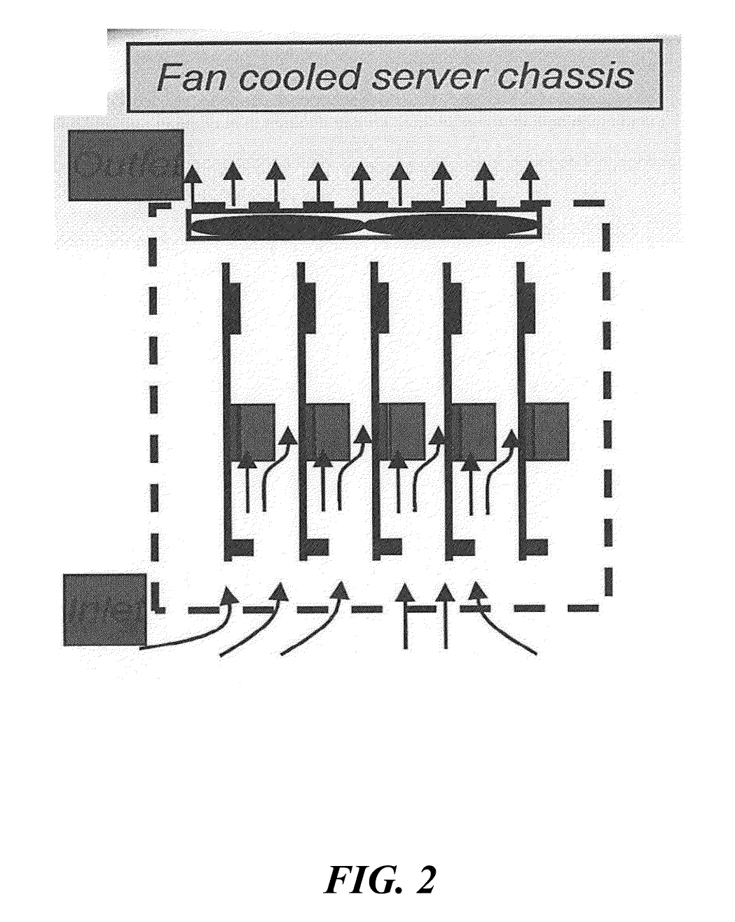

FIG. 2 is an illustration of a prior art server chassis which relies on fan cooling alone for the thermal management thereof. As seen therein, the server chassis 201 depicted comprises a housing 203 having an inlet portion 205 and an outlet portion 207. A fan 209 is disposed adjacent to the outlet portion 207.

The housing 203 has a plurality of PCB boards 211 disposed therein. Each PCB board 211 is equipped with the circuitry needed to operate the server or a portion thereof, which typically includes a microprocessor 213. Each PCB board 211 is further equipped with a heat sink 215 which is in thermal contact with said microprocessor 213.

In operation, the fan 209 creates a flow of air which enters the housing 203 by way of the inlet portion 205 and exits the housing 203 by way of the outlet portion 207. In doing so, the flow of air traverses the PCB boards 211 and the heat sinks 215 disposed thereon, thus cooling the heat sinks 215 and hence the microprocessors 213.

Although systems of the type depicted in FIG. 2 have been used extensively in the art, the limitations of these systems have become apparent over time. In particular, as the size of microelectronic devices has continued to decrease, newer generations of servers have been introduced with increasingly greater circuit densities. This has significantly increased the thermal load within server chassis to the point where fan-based thermal management systems can no longer provide adequate thermal management to enable these devices to operate at optimal conditions.

The problem is especially problematic with older servers. In particular, while it is frequently desirable to retrofit existing servers with improved PCB boards offering greater performance, the thermal footprint associated with these devices often severely taxes the thermal management system of the server, which may have been designed to handle significantly smaller thermal loads.

It has now been found that synthetic jet ejectors provide an efficient and effective solution to these problems. In particular, the performance of fan-based thermal management systems is often hindered by boundary layer conditions, which limit the ability of a heat sink to transfer heat to the ambient environment. However, the synthetic jets associated with a synthetic jet ejector may be used to effectively disrupt such boundary layers, thus providing a more efficient transfer of heat to the ambient environment. Hence, the suitable placement of synthetic jet ejectors in a fan-based thermal management system may be used to efficiently augment the performance of such a system, thus allowing it to handle a larger thermal load. Moreover, synthetic jet ejectors are small enough to be mounted in a sever chassis near a heat source, or may utilize a distribution system to distribute synthetic jets to the location of one or more heat sources. Consequently, thermal management systems are especially useful in retrofitting existing server chassis which are equipped with only a fan-based thermal management system.

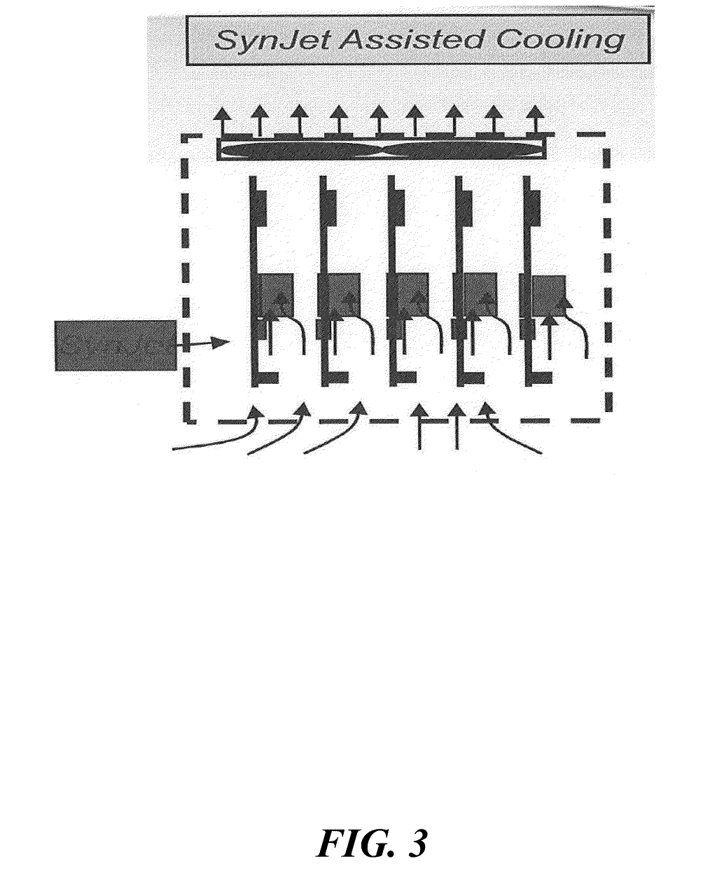

FIG. 3 is an illustration of a particular, non-limiting embodiment of a server chassis made in accordance with the teachings herein which relies on a fan-based thermal management system, in conjunction with a synthetic jet based thermal management system, for the thermal management thereof. As seen therein, the server chassis 301 depicted comprises a housing 303 having an inlet portion 305 and an outlet portion 307. A fan 309 is disposed adjacent to the outlet portion 307.

The housing 303 has a plurality of PCB boards 311 disposed therein. Each PCB board 311 is equipped with the circuitry needed to operate the server or a portion thereof, which typically includes one or more microprocessors 313. Each PCB board 311 is further equipped with one or more heat sinks 315 which are in thermal contact with said microprocessors 313.

The server chassis 301 in this embodiment is further equipped with one or more synthetic jet ejectors 317 which emit one or more synthetic jets. These synthetic jets may be directed onto, across or near the surfaces of the heat sinks 315, either directly or through the use of a synthetic jet distribution system.

In operation, the fan 309 creates a global flow of air which enters the housing 303 by way of the inlet portion 305 and exits the housing 303 by way of the outlet portion 307. In doing so, the flow of air traverses the PCB boards 311 and the heat sinks 315 disposed thereon. Meanwhile, the synthetic jets create a localized, turbulent flow of fluid which disrupts the boundary layer over the surfaces of the heat sinks 315, thus cooling the heat sinks 315 and hence the microprocessors 313 and facilitating the transfer of heat to the external environment. The highly directional flow of fluid attendant to the creation of a synthetic jet also moves the heated fluid a significant distance away from the heat source, where it may be readily rejected to the external environment by the fan-based thermal management system.

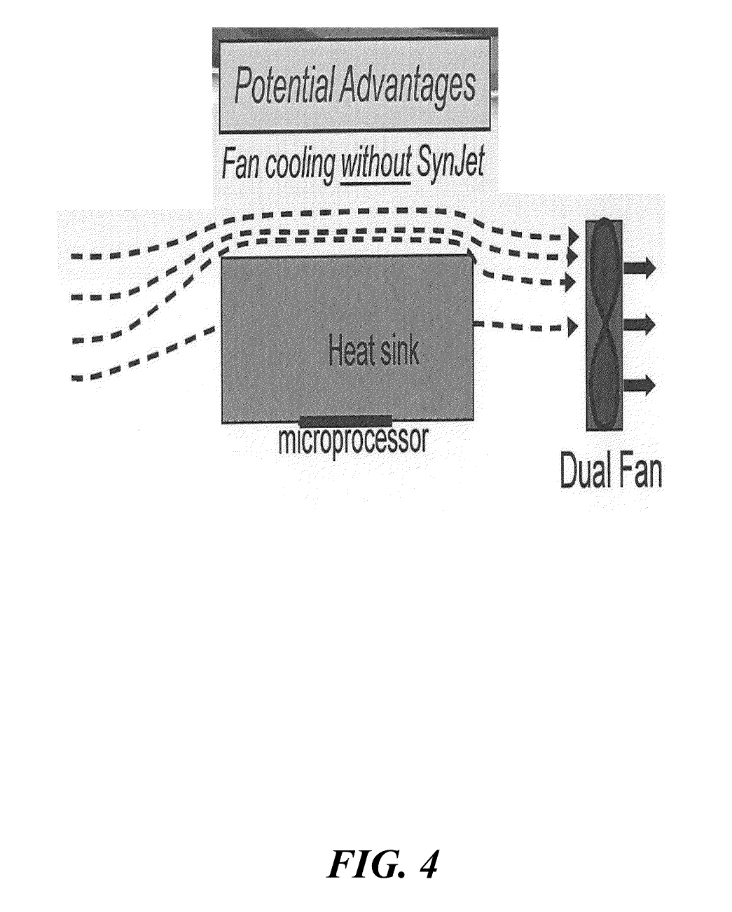

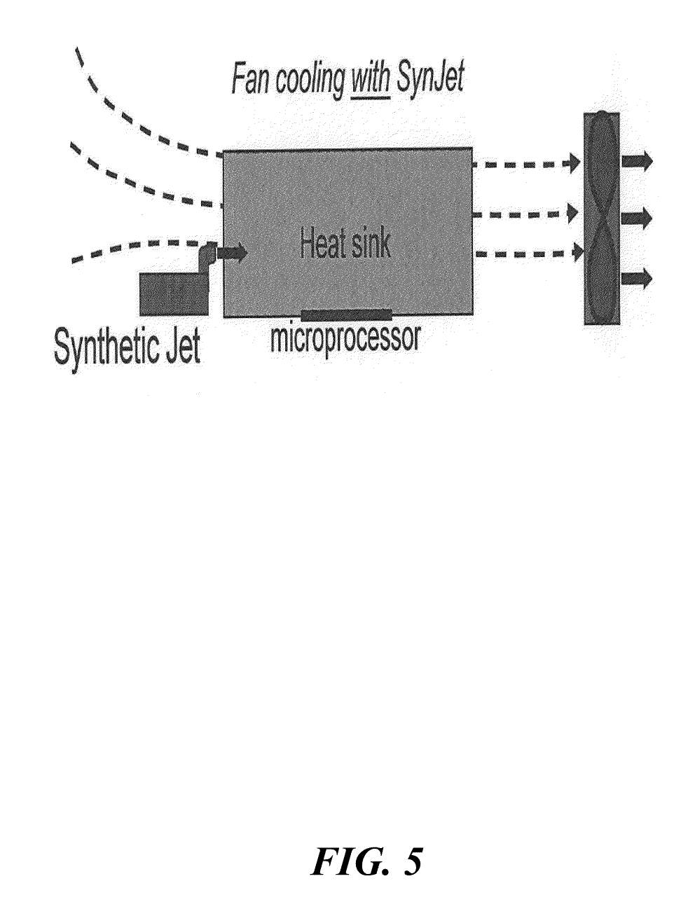

A further advantage of the system of FIG. 3 may be appreciated with respect to FIGS. 4-5 which illustrate, respectively, the flow characteristics of the systems of FIGS. 2 and 3. As seen therein, in the system of FIG. 2 (depicted in FIG. 4), the fluidic flow provided by the fan-based thermal management system only partially penetrates the channels and spaces between adjacent fins of the heat sink. By contrast, as seen in the system of FIG. 3 (depicted in FIG. 5), the use of a synthetic jet ejector causes the fluidic flow to more efficiently penetrate the channels and spaces between adjacent fins of the heat sink, thus resulting in more efficient transfer of heat to the external environment.

The improved heat transfer provided by the system of FIG. 3 over the system of FIG. 2 provides other advantages as well. In particular, such a system enables the use of smaller fans which can operate at slower speeds. This, in turn, reduces the noise attendant to the use of a fan, reduces the cost of the system, and improves the reliability of the system. Moreover, the improved heat transfer coefficients and flow rates attendant to the system of FIG. compared to the system of FIG. 2) enables the use in the server chassis of PCB boards having higher processor power. In addition, the synthetic jet ejector system may be provided as a retrofit solution which is hot swappable.

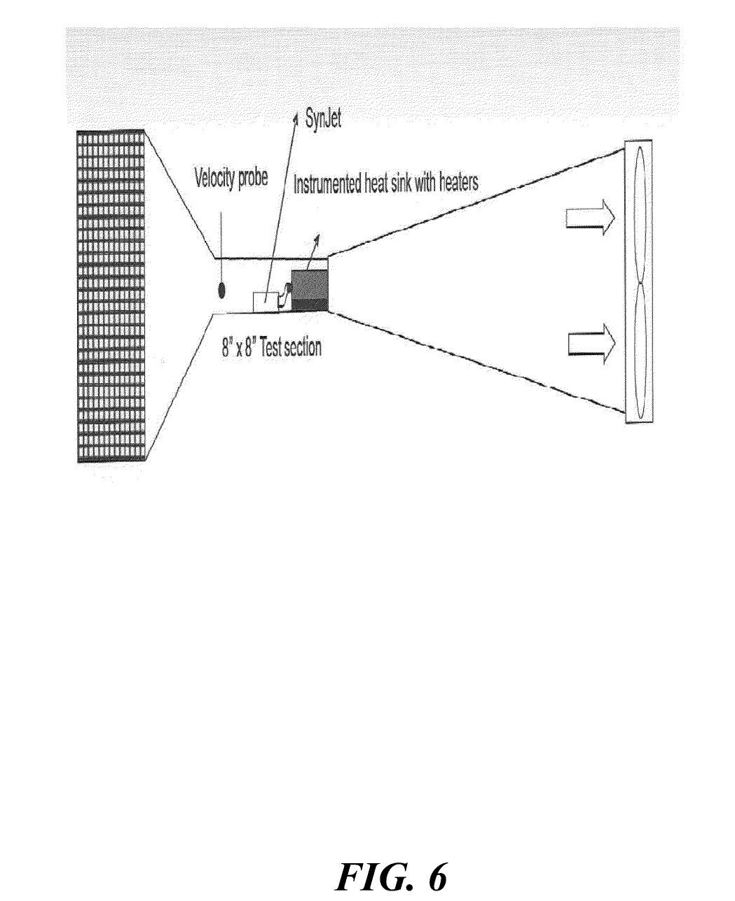

FIG. 6 illustrates a particular, non-limiting embodiment of an experimental set-up that may be used to determine the improvements achievable with a system of the type depicted in FIG. 3. The experimental set-up 601 depicted therein comprises a housing 603 having an inlet 605 and an outlet 607 which are in fluidic communication with each other by way of a test section 609. The outlet 607 is equipped with a fan 611 which creates a global flow of fluid through the test section 609. The area of the test section 609 may be varied from one experiment to another, but may be, for example, an 8×8 region.

The test section 609 is further equipped with a heat source 613, a heat sink 615 and a synthetic jet ejector 617 which directs a synthetic jet into each of the channels formed by adjacent fins of the heat sink 615. The heat source 613 will typically be instrumented to provide a known output of heat so the ability of the system to transfer heat may be readily measured. The test section 609 is further equipped with a velocity probe 619 to measure fluid velocity upstream of the heat sink 615.

The experimental set-up 601 depicted in FIG. 6 is particularly useful for measuring the improvements in heat transfer and efficiency in a system of the type depicted in FIG. 3 as compared to a system of the type depicted in FIG. 2. Advantageously, the experimental set-up 601 allows the wind tunnel cross-section may be varied to achieve different bypass ratios. Moreover, the synthetic jet ejector 617 is placed upstream of the heat sink 615, thus efficiently directing fluidic flow into the heat sink 615. In addition, the flow velocities and heat sink thermals may be readily measured.

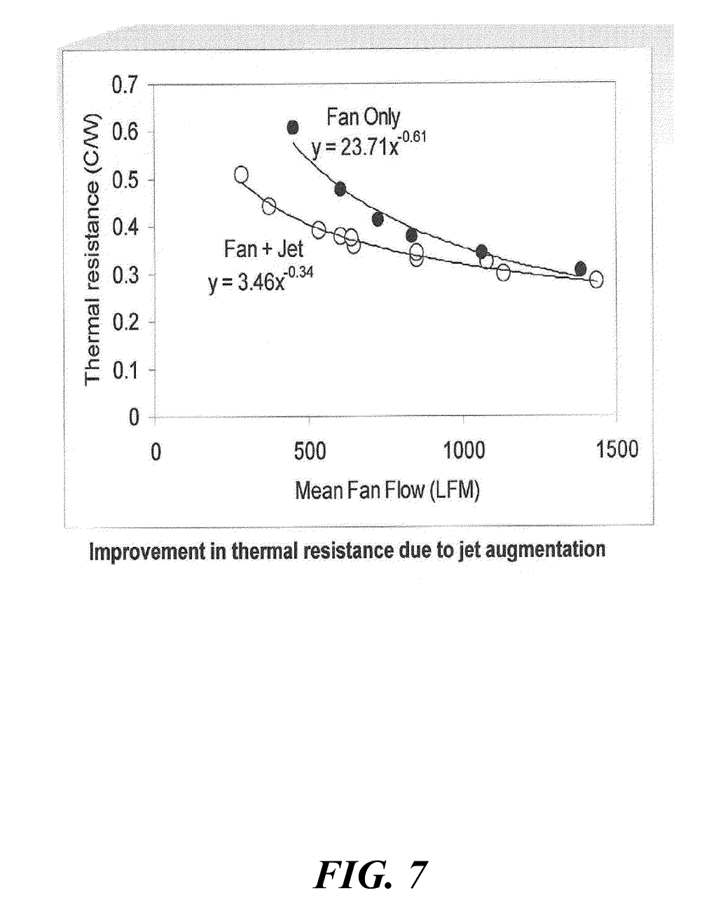

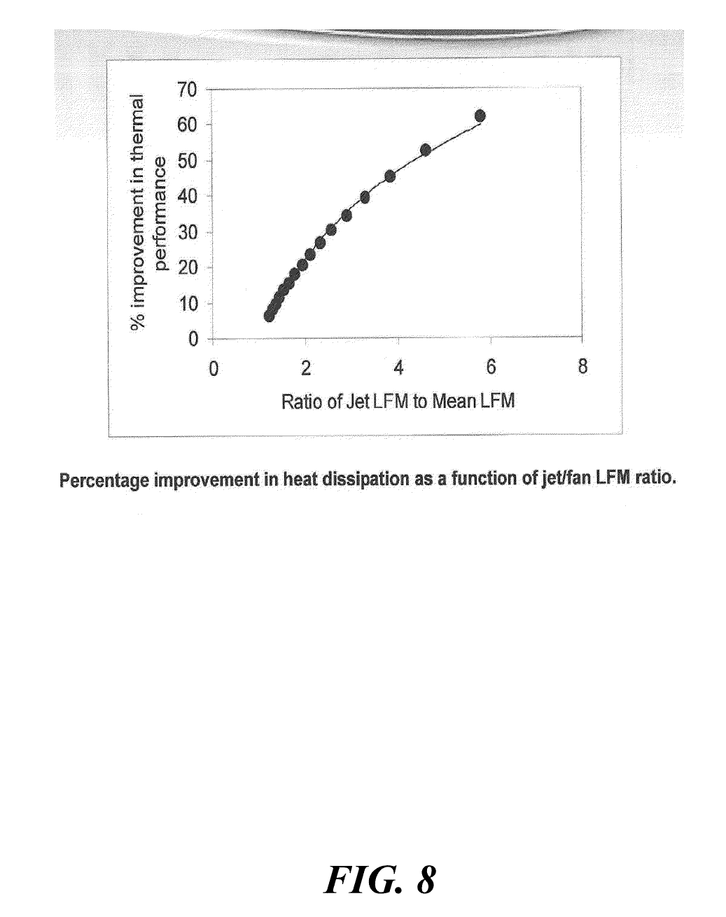

FIGS. 7-8 depict results achieved with the experimental setup of FIG. 6 in comparing the relative performances of the systems of FIGS. 2 and 3. Thus, FIG. 7 shows the improvement in thermal jet resistance due to jet augmentation in the form of thermal resistance (in C/W) as a function of mean fan flow (in linear feet per minute, or LFM). As seen therein, jet augmentation significantly decreases the thermal resistance of the heat sink.

FIG. 8 illustrates the percentage improvement in heat dissipation as a function of jet/fan LFM ratio achievable with a system of the type depicted in FIG. 3. The graph shown therein is of the percent improvement in thermal performance as a function of the ratio of jet LFM to mean LFM. As seen therein, thermal performance increases significantly with the ratio of jet LFM to mean LFM, though the effect begins to taper off as the ratio of jet LFM to mean LFM increases. It will be appreciated from the foregoing that the ratio of jet velocity to free stream flow velocity is a key metric for determining the performance improvement due to jet augmentation.

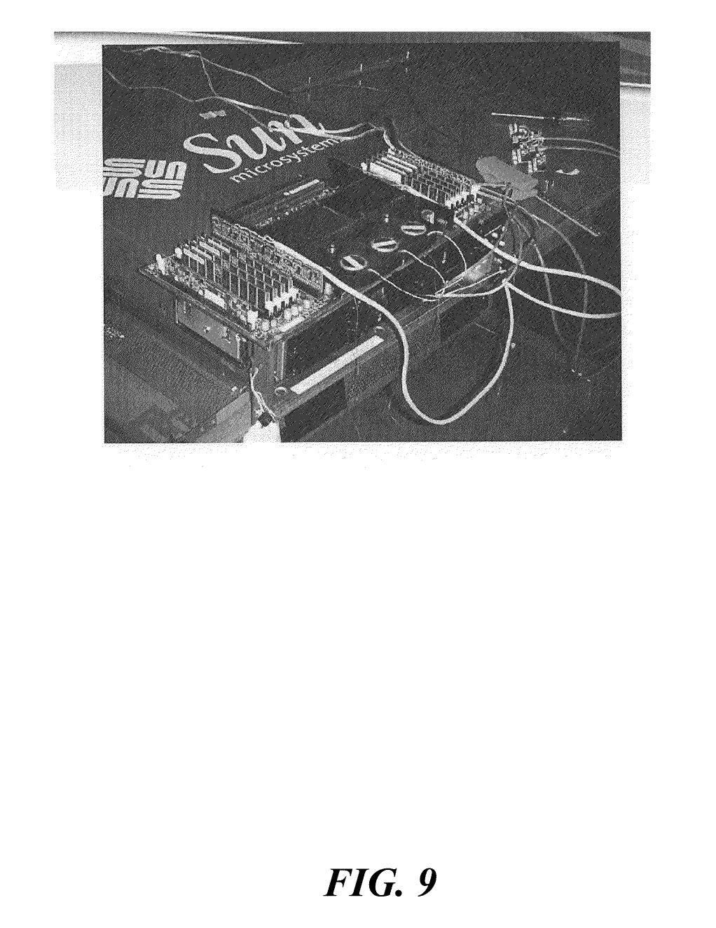

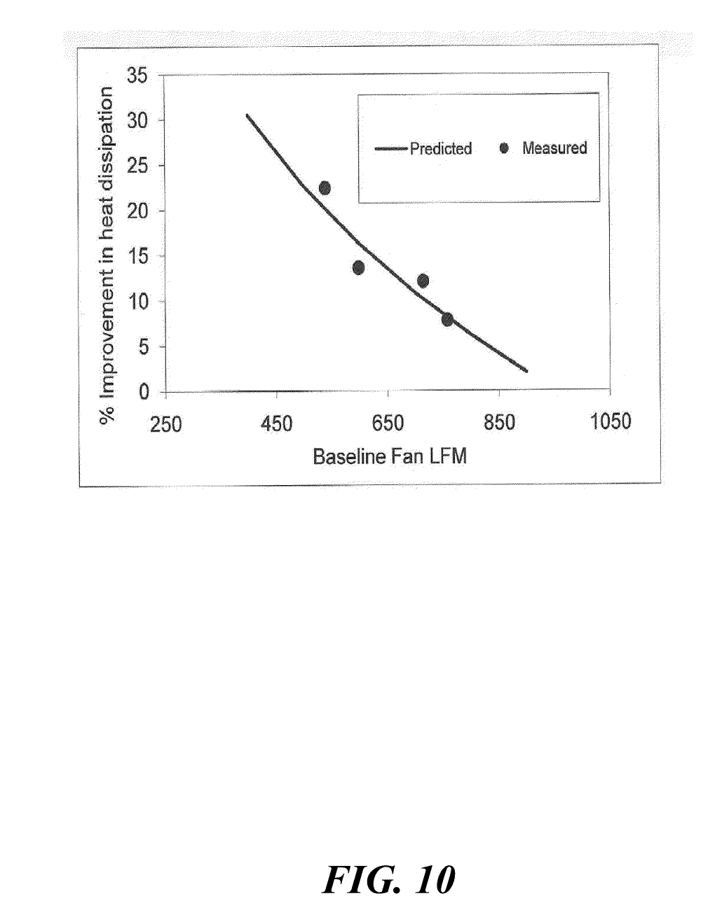

FIG. 9 depicts a server utilized for a series of synthetic jet augmentation studies in accordance with the teachings herein. The server is an 800 W Newisys 4300 quad-socket, 3U, AMD OPTERON™ rack mounted model. The device was utilized in conjunction with the experimental set-up depicted in FIG. 6, and using an inlet speed which varied from 560 LFM (5500 RPM) to 800 LFM (9000 RPM). The results of this experiment are depicted in FIGS. 10-12.

FIG. 10 illustrates the percent improvement in system heat dissipation achievable with the foregoing setup, and includes both measured and predicted values for the percent improvement in heat dissipation as a function of baseline fan flow (in LFM). As seen therein, the use of a synthetic jet ejector provides improvements in heat dissipation at low mean flow rates.

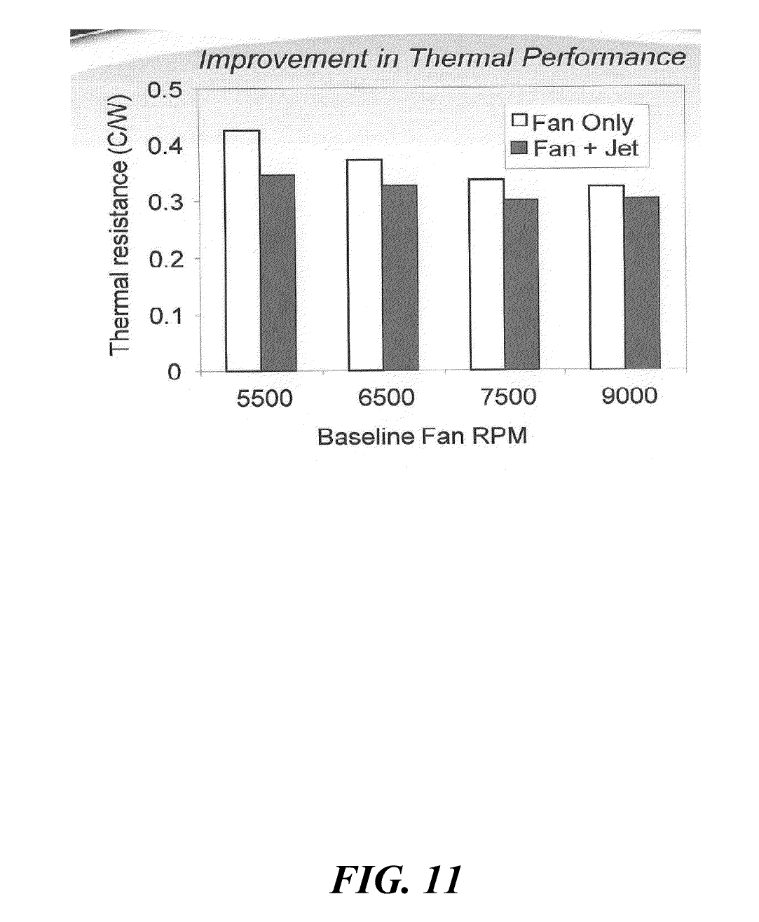

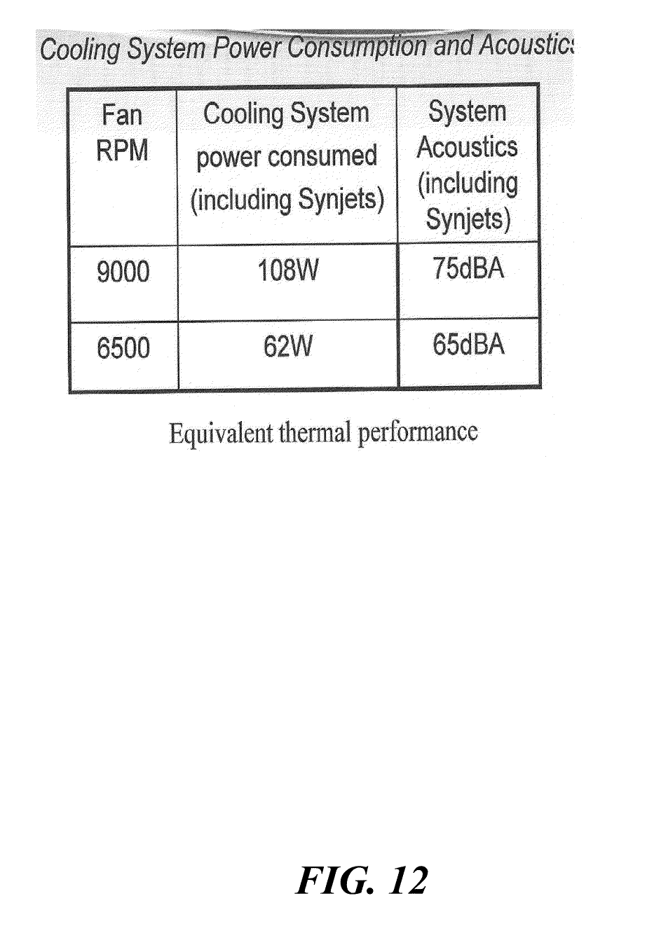

FIG. 11 shows the thermal resistance (in C/W) as a function of baseline fan flow (in RPM), and illustrates the improvement in thermal performance achievable with the foregoing setup when used with synthetic jet augmentation as compared to fan-only thermal management. FIG. 12 shows the equivalent thermal performance, and hence illustrates the cooling system power consumption and acoustics.

As seen by the results of FIGS. 11-12, the use of synthetic jets helped to reduce the speed of system fans from 9000 RPM to 6500 RPM. This resulted in a drop in cooling system power consumption from 108 W to 62 W. This also resulted in a drop in system acoustics from 75 dBA to 65 dBA. Hence, the augmented system was both more energy efficient and quieter than the corresponding fan-only system.

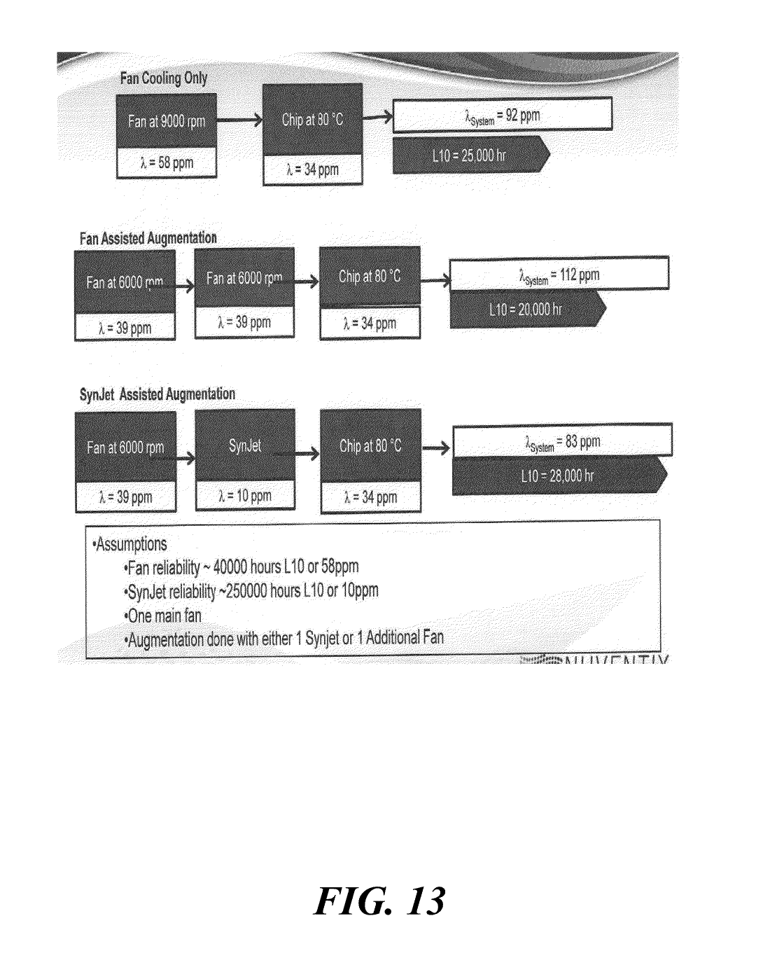

FIG. 13 illustrates the calculated effect of synthetic jet augmentation on cooling system reliability. The calculations assume a server of the type depicted in FIG. 9, a fan reliability of about 40,000 hours (L10 or 58 ppm), a synthetic jet ejector reliability of 250,000 hours (L10 or 10 ppm), a single main fan, and an augmentation performed with a single additional fan (in the case of the fan assisted augmentation) or with a single synthetic jet ejector (in the case of the synthetic jet augmentation).

In the fan cooling only case, the fan was operated at 9000 rpm in order to maintain a chip temperature of 80° C. The reliability of the chip was 34 ppm and the reliability of the fan under these conditions was 58 ppm, thus giving a system reliability of 92 ppm and an expected life of 25,000 hours.

In the fan assisted augmentation, the addition of a second fan allowed both fans to be operated at 6000 rpm in order to maintain a chip temperature of 80° C. This improved fan reliability to 39 ppm, but gave rise to a system reliability of 112 ppm and an expected life of only 20,000 hours.

In the synthetic jet assisted augmentation, the addition of a synthetic jet ejector allowed the fan to be operated at 6000 rpm in order to maintain a chip temperature of 80° C. This not only improved fan reliability to 39 ppm, but gave rise to a system reliability of 83 ppm and increased the expected life of the system to 28,000 hours. These results thus demonstrate the improvements in system performance and reliability achievable with synthetic jet augmentation.

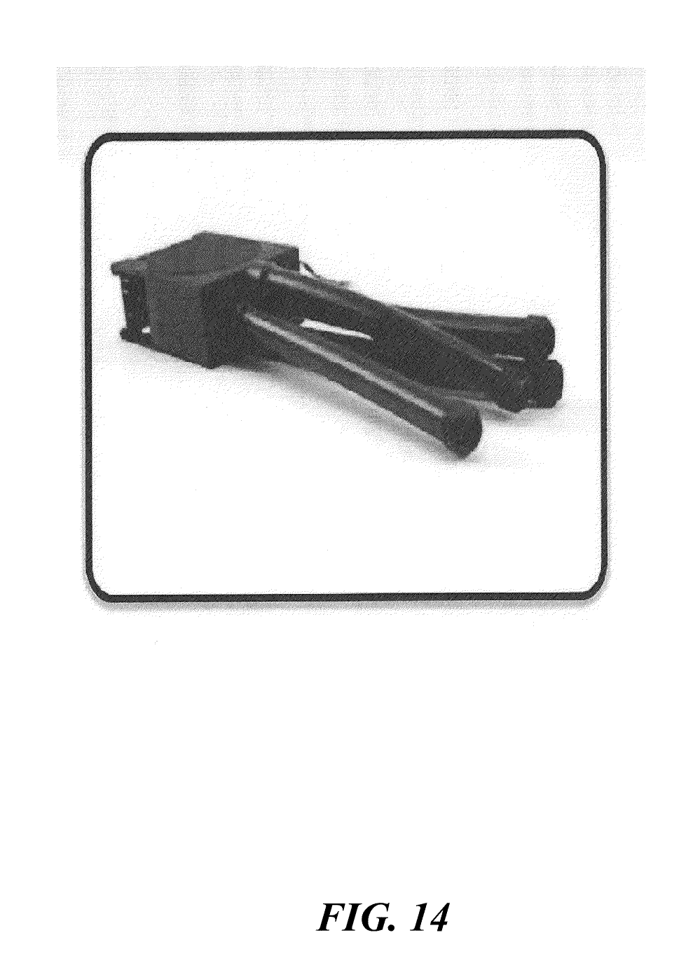

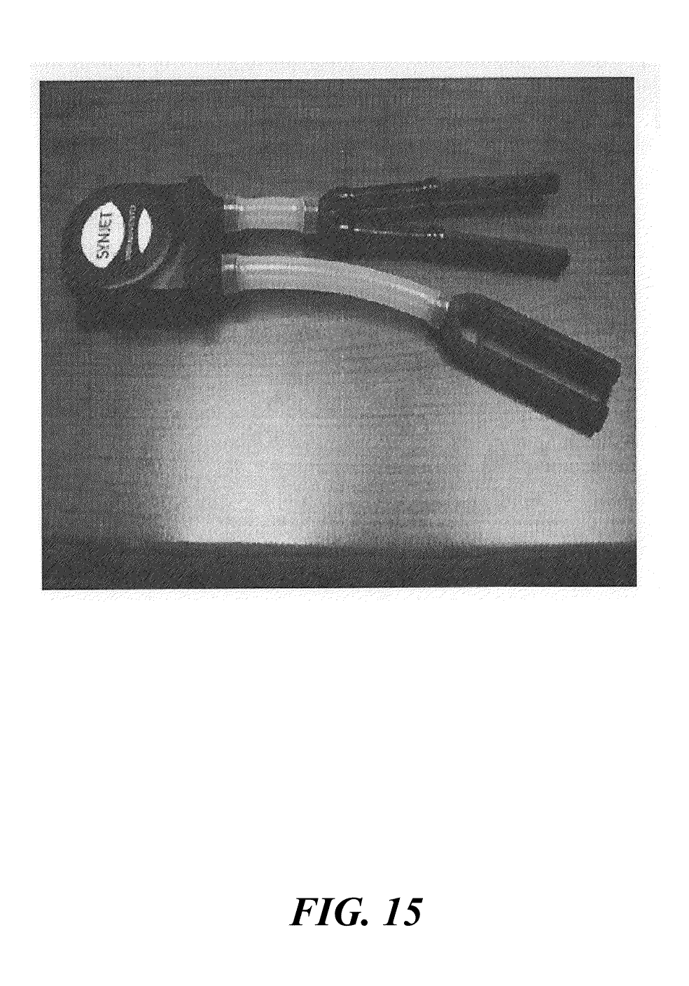

FIGS. 14 and 15 depict particular, non-limiting embodiments of synthetic jet ejectors that can be used in synthetic jet augmentation in accordance with the teachings herein. In the synthetic jet ejector 1401 depicted in FIG. 14, a single synthetic jet actuator 1403 is equipped with a plurality of conduits 1405 from which synthetic jets are emitted. In the synthetic jet ejector 1501 depicted in FIG. 15, a single synthetic jet actuator 1503 is equipped with a plurality of conduits 1505, each of which is further divided into a plurality of sub-conduits 1507 from which synthetic jets are emitted.

The synthetic jet ejectors of FIGS. 14-15 may be utilized to create synthetic jets at large distances from their respective synthetic jet actuators. Thus, for example, tests have shown that conduits of up to 2 m in length may be utilized to produce synthetic jets. Hence, synthetic jet ejectors of the type depicted in FIGS. 14-15 may be utilized to allow a synthetic jet actuator to be placed anywhere in a system where room exists, while still allowing synthetic jets to be created locally at hot spots. This approach represents a significant improvement over conventional approaches such as fan-based thermal management systems, which require large flow rates at a single spot.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A computing device, comprising:
a chassis having an array of printed circuit boards (PCBs) disposed therein, wherein said chassis has a first wall with a first opening therein, and a second wall with a second opening therein, wherein each PCB is equipped with a microprocessor and a heat sink, and wherein each heat sink comprises a plurality of heat fins that define a plurality of longitudinal channels;
a fan which creates a fluidic flow that enters through said first opening and exits through said second opening, said fluidic flow being essentially parallel the longitudinal axes of said plurality of longitudinal channels; and
a synthetic jet ejector which directs at least one synthetic jet through at least one of said plurality of channels.

2. The computing device of claim 1, wherein said computing device is a server.

3. The computing device of claim 1, wherein said first wall has a first plurality of openings therein.

4. The computing device of claim 1, wherein said second wall has a second plurality of openings therein.

5. The computing device of claim 1, wherein said fan is disposed adjacent to said second opening.

6. The computing device of claim 1, wherein said fan is disposed over said second opening.

7. The computing device of claim 1, wherein each of said plurality of channels is formed by a pair of adjacent heat fins.

8. The computing device of claim 1, wherein said synthetic jet ejector directs at least one synthetic jet through a plurality of said channels.

9. The computing device of claim 1, wherein said synthetic jet ejector directs a plurality of synthetic jets through at least one of said channels.

10. The computing device of claim 1, further comprising plurality of synthetic jet ejectors, wherein each of said synthetic jet ejectors directs at least one synthetic jet through at least one of said channels.

11. The computing device of claim 1, further comprising plurality of synthetic jet ejectors, wherein each of said synthetic jet ejectors directs at least one synthetic jet through a plurality of said channels.

12. The computing device of claim 1, further comprising plurality of synthetic jet ejectors, wherein each of said synthetic jet ejectors directs a plurality of synthetic jets through at least one of said channels.

13. A system for testing the effect of synthetic jet cooling in a thermal management system, comprising:
a conduit having a heat sink disposed therein which is in thermal contact with a heat source;
a heat source in thermal contact with said heat sink;
a synthetic jet ejector which directs a synthetic jet onto or across a surface of said heat sink;
a fan which creates an air flow through said conduit from a direction upstream from said heat sink to a direction downstream from said heat sink; and
a velocity probe.

14. The system of claim 13, wherein said velocity probe is disposed upstream of said heat sink.

15. The system of claim 13, wherein said fan is disposed downstream of said heat sink.

16. The system of claim 13, wherein said synthetic jet ejector is disposed in said conduit.

17. The system of claim 16, wherein said synthetic jet ejector is disposed downstream of said velocity probe.

18. The system of claim 13, wherein said heat sink comprises a plurality of heat fins.

19. The system of claim 18, wherein each adjacent pair of heat fins defines a channel, and wherein said synthetic jet ejector directs at least one synthetic jet into each of said channels.
